(19) United States
(12) Patent Application Publication
(10) Pub. No.: US 2009/0249214 A1
(43) Pub. Date: Oct. 1, 2009

(54) Providing a Shared Buffer Between Multiple Computer Terminals

(76) Inventors: Steven F. Best, Georgetown, TX (US); Robert J. Eggers, JR., Austin, TX (US); Janice M. Girouard, Austin, TX (US); Brian P. Sobocinski, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 12/059,756

(22) Filed: Mar. 31, 2008

(51) Int. Cl. G06F 3/048

(52) U.S. Cl. 715/740

(57) ABSTRACT

Disclosed is a method, system, and computer-readable medium with executable code for controlling the operation of multiple client terminals from a single keyboard and mouse of a server terminal. A buffer sharing logic of the server terminal and the client terminals is used to transmit and receive user input between the computers. The server terminal may use buffer sharing logic to cycle between desktop views or program windows of processes running on the connected client terminals. A user may use an ALT-TAB command to select a desktop view or program window of a connected client terminal. Once a screen or desktop is chosen, the user of the server terminal give focus of the selected application on a display connected to the server terminal. Additionally, the buffer sharing logic allows the user to dynamically copy and move data between the computer terminals at will.

The present invention is related to the subject matter of the following commonly assigned, co-pending, and concurrently filed United States patent applications: Ser. No. ______ (Docket No. AUS920080259US1) entitled “PROVIDING A SHARED DESKTOP INTERFACE OF MULTIPLE COMPUTER TERMINALS”. The content of the above-referenced applications are incorporated herein by reference.

### BACKGROUND OF THE INVENTION

1. Technical Field

The present invention relates in general to computer terminals. Still more particularly, the present invention relates to sharing buffer space between multiple computer terminals to allow for a single user to control multiple computer terminals through a single set of input devices.

2. Description of the Related Art

Computer resources have become inexpensive and as such it has become commonplace to have multiple computer terminals in a home or office. However, there are times when a person may need to concurrently access programs or data on several different computer terminals. In many situations, space may be too limited to have multiple sets of input devices operating in tandem.

### SUMMARY OF THE INVENTION

Disclosed is a method, system, and computer-readable medium with executable code for controlling the operation of multiple client terminals from a single keyboard and mouse of a server terminal. A buffer sharing logic of the server terminal and the client terminals is used to transmit and receive user input between the computers. The server terminal may use buffer sharing logic to cycle between desktop views or program windows of processes running on the connected client terminals. A user may use an ALT-TAB command to select a desktop view or program window of a connected client terminal. Once a screen or desktop is chosen, the user of the server terminal give focus of the selected application on a display connected to the server terminal. Additionally, the buffer sharing logic allows the user to dynamically copy and move data between the computer terminals at will.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, will best be understood by reference to the following detailed descriptions of an illustrative embodiment when read in conjunction with the accompanying drawings, wherein:

FIG. 1 is a block diagram of a computer terminal in which the present invention may be implemented; and

FIG. 2. is a block diagram of an exemplary system for implementing input/output device buffer based control of multiple client terminals from a single server terminal.

FIG. 3. is an exemplary illustration of a virtual desktop extension system for switching between desktop views of a server terminal and one or more client terminals.

FIG. 4. is an exemplary illustration of an Application Selection Interface (ASI) system for switching between applications of a server terminal and one or more client terminals.

FIG. 5. is a high-level logical flowchart of an exemplary method for synchronizing input buffers and application displays of a server terminal and one or more client terminals

### DETAILED DESCRIPTION OF THE PREFERRED EMBODIMENT

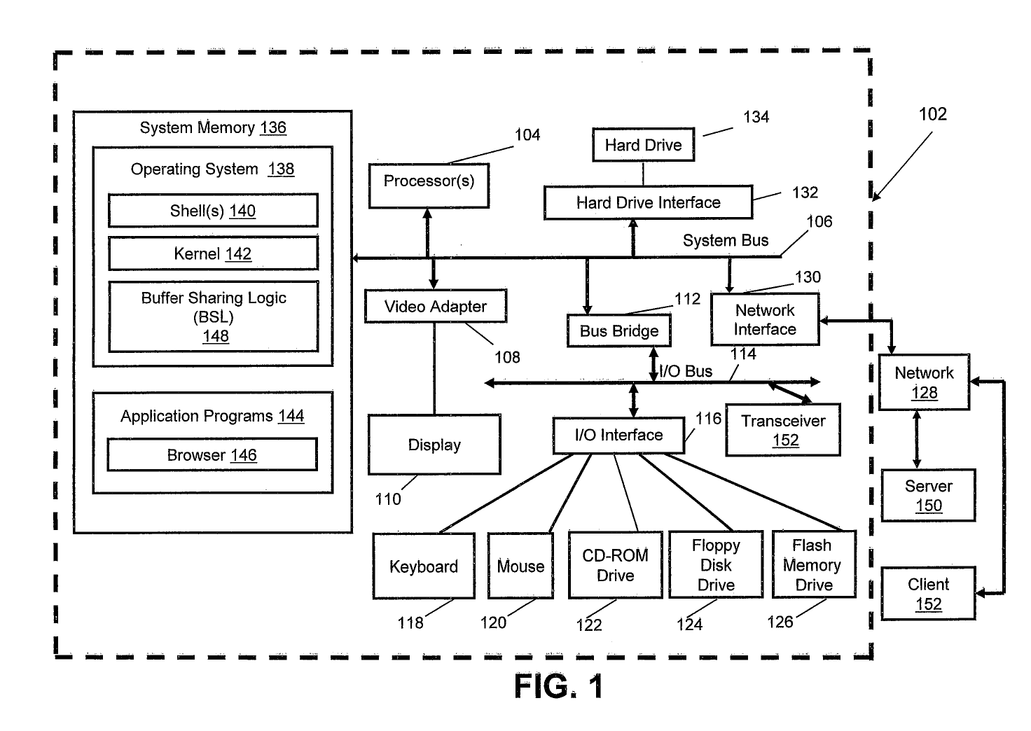

With reference now to FIG. 1, there is depicted a block diagram of an exemplary Server Terminal 102 in which the present invention may be implemented. Server Terminal 102 includes one or more processors 104 that are coupled to a system bus 106. A video adapter 108, which drives/supports a display 110, is also coupled to system bus 106. System bus 106 is coupled via a bus bridge 112 to an Input/Output (I/O) bus 114. An I/O interface 116 is coupled to I/O bus 114. I/O interface 116 affords communication with various I/O devices, including a keyboard 118, a Mouse 120, a Compact Disk-Read Only Memory (CD-ROM) drive 122, a floppy disk drive 124, and a flash drive memory 126. Keyboard 118 may be a standard keyboard (e.g., QWERTY style or similar), or a condensed alphanumeric keypad. The format of the ports connected to I/O interface 116 may be any known to those skilled in the art of computer architecture, including but not limited to Universal Serial Bus (USB) ports.

Server Terminal 102 is able to communicate with a software deploying server 150 via a network 128 using a network interface 130, which is coupled to system bus 106. Network Interface 130 may utilize wired or wireless technology such as a wireless local area network technology to connect with Network 128 via an access point. Network 128 may be an external network such as the Internet, or an internal network such as an Ethernet or a Virtual Private Network (VPN). Note the software deploying server 150 may utilize a same or substantially similar architecture as Server Terminal 102.

A hard drive interface 132 is also coupled to system bus 106. Hard drive interface 132 interfaces with a hard drive 134. In a preferred embodiment, hard drive 134 populates a system memory 136, which is also coupled to system bus 106. System memory is defined as a lowest level of volatile memory in Server Terminal 102. This volatile memory includes additional higher levels of volatile memory (not shown), including, but not limited to, cache memory, registers and buffers. Data that populates system memory 136 includes operating system (OS) 138 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140 (also called a command processor) is generally the highest level of the operating system software hierarchy and serves as a command interpreter. The shell 140 provides a system prompt, interprets commands entered by keyboard or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a browser 146. Browser 146 includes program modules and instructions enabling a World Wide Web (WWW) client (i.e., Server Terminal 102) to send and receive network messages to the Internet using HyperText Transfer Protocol (HTTP) messaging, thus enabling communication with software deploying server 150.

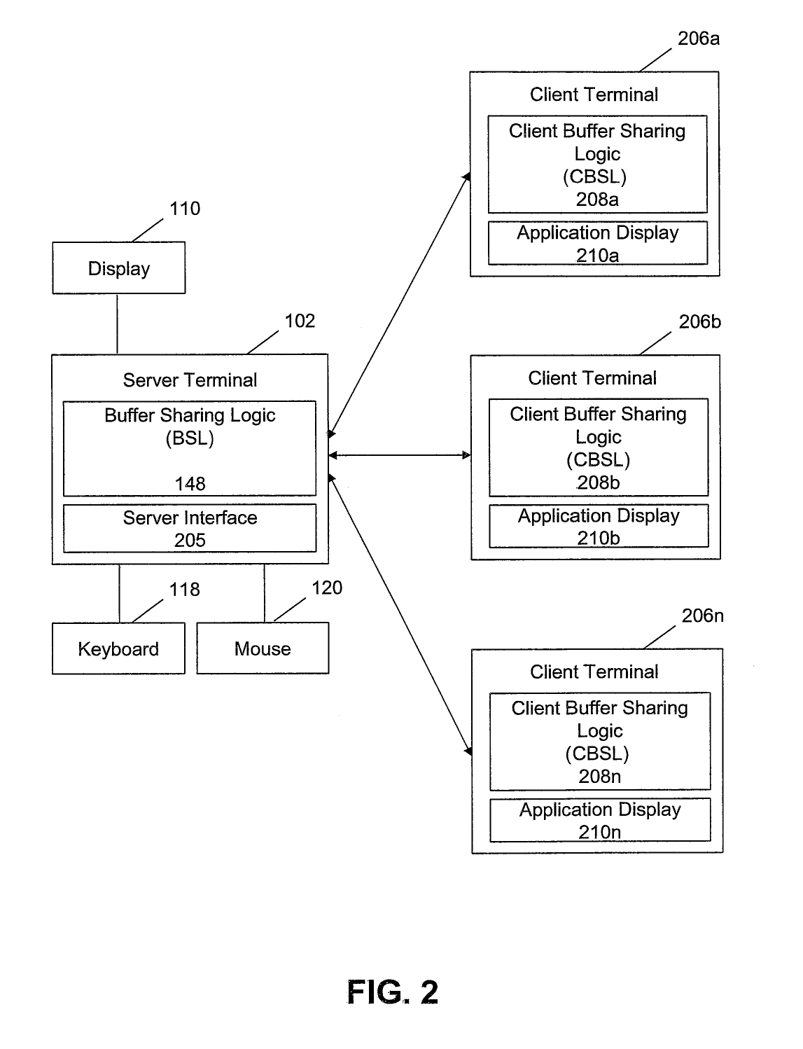

Application programs 144 in Server Terminal's 102 system memory (as well as software deploying server's 150 system memory) also include a Buffer Sharing Logic (BSL) 148. BSL 148 includes code for implementing the processes described in FIG. 2-5. In one embodiment, Server Terminal 102 is able to download BSL 148 from software deploying server 150, including in an “on demand” basis, as described in greater detail below in FIG. 2.

The hardware elements depicted in Server Terminal 102 are not intended to be exhaustive, but rather are representative to highlight essential components required by the present invention. For instance, Server Terminal 102 may include alternate memory storage devices such as magnetic cassettes, Digital Versatile Disks (DVDs), Bernoulli cartridges, and the like. These and other variations are intended to be within the spirit and scope of the present invention.

Note further that, in an alternate embodiment of the present invention, software deploying server 150 performs all of the functions associated with the present invention (including execution of BSL 148), thus freeing Server Terminal 102 from having to use its own internal computing resources to execute BSL 148.

With reference now to FIG. 2, a block diagram of the input/output device buffer system used in an exemplary embodiment of the present invention is presented. Note also the architecture shown in FIG. 1 for Server Terminal 102 may be substantially implemented in Server Terminal 102 and Client Terminals 206a-n shown in FIG. 2. Additionally, by including a Network Interface 106 in the architecture of Server Terminal 102, the appropriate elements illustrated as components of Server Terminal 102 can communicate with other clients in the same network as Server Terminal 102 (e.g., Client Terminals 206a-n shown below in FIG. 2).

A Server Terminal 102 connected to one or more Client Terminals 206a-n by Network 128 initiates an instruction to connect to one or more Client Terminals 206a-n. Input devices (e.g., Keyboard 118 and Mouse 120) connected to Server Terminal 102 are monitored by BSL 148. BSL 148 is a logic internal to Server Terminal 102 and may additionally interpret data inputted by a person using an input device of Server Terminal 102. This data may be then be transmitted to a connected Client Terminal 206a-n enabling a user to manage processes running on connected Client Terminals 206a-n. Additionally, BSL 148 may present the user of Server Terminal 102 with a graphical user interface which enables the user to view and switch between Application Displays 210a-n of the connected Client Terminals 206a-n at will.

A user of Server Terminal 102 may utilize Network 128 to connect to Client Terminals 206a-n. In an exemplary embodiment, this is accomplished by Server Terminal 102 using a Network Interface 106 to scan for available Client Terminals 206a-n on the same Network 128. When Server Terminal 102 completes the scan for Client Terminals 206a-n available for connection, the user is presented with a selection Client Terminals 206a-n available for direct connection. The user of Server Terminal 102 may then select one or more Client Terminals 206a-n which the user desires to exert control over. Once a connection has been established to a selected Client Terminal 206, the Client Terminal 206 begins continuously transmitting an Application Display 210 to Server Terminal 102, as long as the connection is maintained. Alternatively, Client Terminals 206a-n may be preconfigured to connect to Server Terminal 102. In this case the scan for available Client Terminals 206a-n serves to confirm that a Client Terminal 206 exists on the network and is ready for connection.

Client Terminals 206a-n are configured with Client Buffer Sharing Logic (CBSL) 208a-n. CBSL 208a-n interfaces with I/O device buffers, Application Displays 210a-n, and running processes and resources of a Client Terminal 206a-n to provide control to Server Terminal 102. The Application Display 210a-n is a real-time view of the desktop user interface of the same Client Terminal 206a-n, or an application running on the same Client Terminal 206a-n.

Server Terminal 102 receives Application Display 210a-n transmitted by Client Terminal 206a-n. In one embodiment, BSL 148 may then present the Application Displays 210a-n of Client Terminals 206a-n as virtual desktop extensions of the Server Interface 205 of Server Terminal 102 being presented on Display 110. The virtual desktop extensions are appended to an edge of the Server Interface 205 of Server Terminal 102. Server Interface 205 is a real-time view of the desktop user interface of Server Terminal 102. BSL 148 utilizes actions performed by user operating connected input devices to switch the view between several Application Displays 210a-n of connected Client Terminals 206a-n. This is accomplished by an input device (e.g., Keyboard 118 and Mouse 120) of Server Terminal 102 to move a cursor to the edge of a Server Interface 205 currently being viewed on Display 110. The cursor is a visual identifier of Server Interface 205 that may be manipulated by an input device connected to Server Terminal 102. By means of a user operating an input device to move the cursor to the edge of Server Interface 205, BSL 148 autonomously changes the view shown on Display 110 to that of an Application Display 210 of a connected Client Terminal 206a-n. Additionally, the user may also use a macro, or a “hot key” combination of button pressed performed of the input devices connected to Server Terminal 102 to change the view shown on the display to an Application Display 210a-n of a connected Client Terminal 206a-n. Simultaneously, Server Terminal 102 may issue an instruction to synchronize input device buffers of the connected Client Terminals 206a-n to the input device buffers of Server Terminal 102. This enables an input device connected to Server Terminal 102 to control actions performed by a Client Terminal 206, while simultaneously viewing the Application Display 210 of the same Client Terminal 206 on Display 210. Additionally, the Application Display 210 presented on Display 110, may include text to identify the originating Client Terminal 206 (e.g., a name of the Client Terminal 206, Internet Protocol (IP) address).

For exemplary purposes, when Server Terminal 102 is connected to Client Terminal 206a, BSL 148 may present Application Display 210a as part of a virtual desktop extension of the user interface of Server Terminal 102. In this example, the Application Display 210a portion of the virtual desktop extension is appended to the left edge of Server Interface 205. When the user of Server Terminal 102 moves the cursor to the left edge of the user interface currently being viewed on Display 110, the view of Display 110 changes to that of Application Display 210a. The user may then use the input devices of Server Terminal 102 to control processes of Client Terminal 206a, while viewing the Application Display 210a on Display 110. Moving the cursor to the right edge of Application Display 210a, currently being viewed on Display 110, changes the view of Display 110 back to a view of Server Interface 205. The user may then use the input devices of Server Terminal 102 to control Server Terminal 102. The user may also use a keyboard macro command (e.g., Alt-Tab) to cycle between Server Interface 205 and Application Displays 210a-n viewed on Display 110.

BSL 148 and CBSL 208a-n may additionally contain further functionality to support integration of applications open on Client Terminals 206a-n into a running operating system of Server Terminal 102. The applications running on connected Client Terminals are Application Displays 210a-n that may be integrated into Server Interface 205 by BSL 148 and displayed for interaction on Display 110 of Server Terminal 102 as applications of Server Terminal 102. In this embodiment, the integration of the Application Displays 210a-n allows the user of Server Terminal 102 to use input devices to manipulate and switch between program windows of Client Terminals 206a-n as applications integrated into Server Interface 205. A graphical user interface may also be presented on Display 110 that allows the user to select a specific application as the active application. This graphical user interface may also include text to identify the originating computer terminal (e.g., a name of the Client Terminal 206, Internet Protocol (IP) address).

The user interface of BSL 148 allows the user of Server Terminal 102 to select one or more connected Client Terminals 206a-n to synchronize input device buffers to the input device buffer of Server Terminal 102. CBSL 208a-n monitors activity and the input device buffer of a Client Terminal 206a-n, and synchronizes the input device buffer with input received from Server Terminal 102. Once the input device buffer of Server Terminal 102 has been synchronized to the input device buffer of Client Terminals 206a-n, keyboard and mouse input of Server Terminal 102 may be used to manipulate the user interface of Server Terminal 102 and/or one or more Client Terminals 208a-n. This may be accomplished by the user of Server Terminal 102 selecting which terminals to exert control over at a given time.

For exemplary purposes, when Client Terminal 206a has an open word processor program and an open email client program, the user of Server Terminal 102 may use mouse input or a keyboard macro command (e.g., Alt-Tab) to cycle between Application Displays 210a-n of the word processor and email client program in addition to any open program windows of Server Terminal 102 or Application Displays 210b-n of other Client Terminals 206b-n. This action may be performed as desired by the user.

In addition, when input device buffer of Server Terminal 102 has been synchronized to input device buffer of Client Terminals 206a-n, data buffers may also be linked between Server Terminal 102 and Client Terminals 206a-n. In this embodiment, data selected on one terminal may be copied to, or manipulated on, another terminal. This functionality is transparent to the user and serves to provide the user with control of Client Terminals 206a-n that act as an extension of the Server Terminal 102, with no loss in basic operating system functionality. This is accomplished using logic internal to the Server Terminal 102 and Client Terminals 206a-n (e.g., BSL 148, CBSL 208a-n) that through a connection of Server Terminal 102 and Client Terminals 206a-n, autonomously synchronizes device input and data buffers.

For example, if a person using Server Terminal 102 selects to “copy” a group of words in a word processing application running on Server Terminal 102, the user may then switch to the Application Display 210a of currently connected Client Terminal 206a and “paste” the same group of words into a word processing application of Client Terminal 206a. Similarly, this connection allows for “drag-and-drop” functionality between Server Terminal 102 and connected Client Terminals 206a-n.

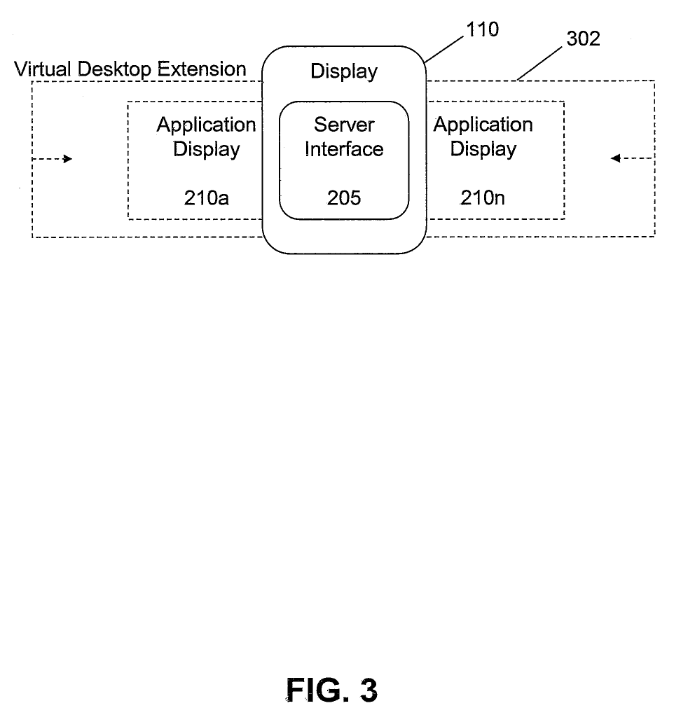

With reference now to FIG. 3, an exemplary diagram of the virtual desktop extension system used in an exemplary embodiment of the present invention is presented. Virtual Desktop Extension 302 is an exemplary representation of the orientation of the Server Interface 205 and Application Display 210a-n. In the Virtual Desktop Extension 302 The Application Displays 210a-n are located on adjacent edges of the Server Interface 205. Using an input device, the user may move a cursor towards the edge of the Server Interface 205 presented on Display 110. This action will move Application Display 210a-n into the view presented on Display 110.

For exemplary purposes, when the cursor is moved to the left side of Server Interface 205, currently being viewed on Display 110, BSL 148 autonomously moves Application Display 210a into the view presented on the display. Moving the cursor to the right side conversely triggers BSL 148 to autonomously move Server Interface 205 back into view on Display 110.

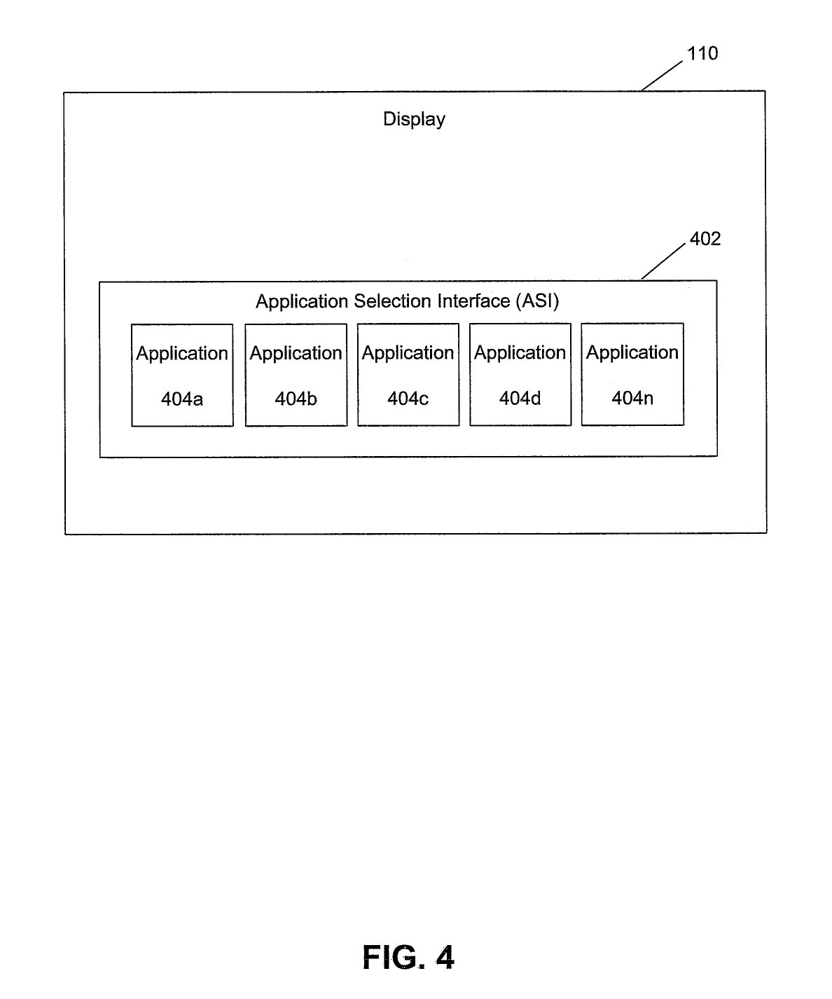

With reference now to FIG. 4, an exemplary diagram of the Application Selection Interface (ASI) system used in an exemplary embodiment of the present invention is presented. Application Selection Interface (ASI) 402 is an exemplary representation of a graphical user interface that may be used in the present embodiment. ASI 402 may be presented on the user interface of Server Interface 205 or Application Display 210a-n. ASI 402 may be visible only when a specific input device command is performed, or may always be visible on Server Interface 205 when Server Terminal 102 is connected to one or more Client Terminals 206a-n. ASI 402 integrates with BSL 148 and presents the user with a graphical list of running Applications 404a-n on Server Terminal 102 and/or one or more Client Terminals 206a-n. ASI 402 allows a user to use an input device (e.g., keyboard 118, mouse 120) to select a desired Application 404a-n. Upon the user selecting an Application 404a-n, BSL 148 autonomously brings the selected Application 404a-n into view on display 110.

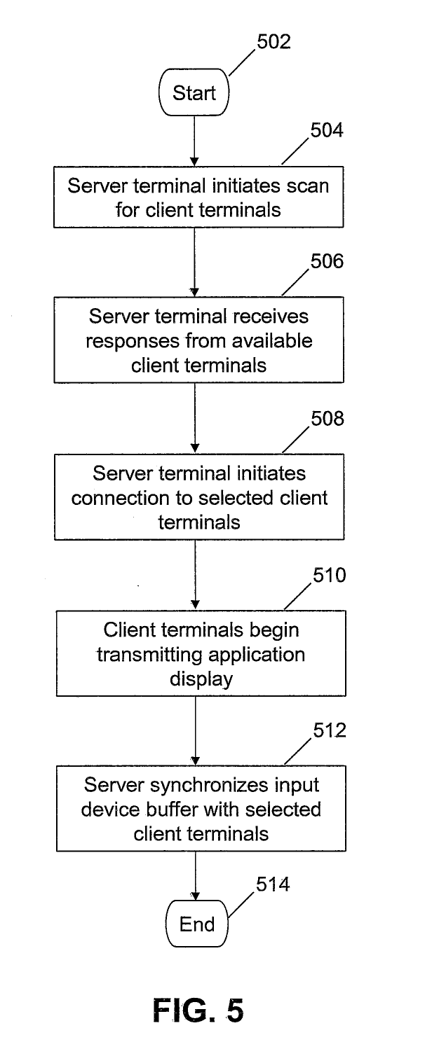

With reference now to FIG. 5, a high-level logical flowchart of an exemplary method for synchronizing input buffers and application displays of a server terminal and one or more client terminals is presented. After initiator block 502, the server terminal initiates a scan for other client terminals available for a direct connection (block 504). The server terminal then receives responses from client terminals available for a direct connection to the server terminal (block 506). Following this, a person using the server terminal selects the client terminals for which the person desires to connect to. The server terminal then initiates a connection to the selected client terminals (block 508). Upon the connection being established, the client terminals begin transmitting an application display to the server terminal (block 510). Following this, the server terminal synchronizes the input device buffer of the server terminal with the input device buffer of the selected client terminals (block 512). Once the input device buffers have been synchronized the user of the server terminal may interact with connected client terminals. The process then ends at terminator block 514.

Although aspects of the present invention have been described with respect to a computer processor and software, it should be understood that at least some aspects of the present invention may alternatively be implemented as a program product for use with a data storage system or computer system. Programs defining functions of the present invention can be delivered to a data storage system or computer system via a variety of signal-bearing media, which include, without limitation, non-writable storage media (e.g. CD-ROM), writable storage media (e.g. a floppy diskette, hard disk drive, read/write CD-ROM, optical media), and communication media, such as computer and telephone networks including Ethernet. It should be understood, therefore, that such signal-bearing media, when carrying or encoding computer readable instructions that direct method functions of the present invention, represent alternative embodiments of the present invention. Further, it is understood that the present invention may be implemented by a system having means in the form of hardware, software, or a combination of software and hardware as described herein or their equivalent.

Having thus described the invention of the present application in detail and by reference to illustrative embodiments thereof, it will be apparent that modifications and variations are possible without departing from the scope of the invention defined in the appended claims. In addition, many modifications may be made to adapt a particular system, device or component thereof to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A method of operating a client terminal from a server terminal, the method comprising:
transmitting an instruction from the server terminal to a first client terminal to enable interconnection between an output display device buffer of the first client terminal and an output display device buffer of the server terminal;
in response to the server terminal connecting the output display device buffer of the server terminal to the input device buffer of the first client terminal, receiving a display data related to running processes of the first client terminal, wherein the display data related to running processes is received by the server terminal, and includes one or more of:
a display data related to a desktop display of a user interface of an operating system running on the first client terminal,
a display data related to a user interface of a program currently running on the first client terminal;
connecting input/output (I/O) functionality of an input device buffer of an operating system of the first client terminal with an input device buffer associated with an operating system of the server terminal; and
in response to connecting the input device buffer of the operating system of the first client terminal to the input device buffer of the operating system of the server terminal, transmitting operations performed by an input device connected to the server terminal to the first client terminal to control the first client terminal.

2. The method of claim 1, wherein the display data related to running processes on the first client terminal is a desktop display of the user interface of the first client terminal, and the method further comprises, in response to the server terminal detecting a specific operation performed by an input device connected to the server terminal, switching from a display data related to a desktop display of a user interface of an operating system of the server terminal to the display data related to a desktop display of a user interface of an operating system of the first client terminal; and
wherein the specific operation performed by an input device connected to the server terminal is an alt-tab key combination, and the method further comprises, switching between display data in an order of display data related to the desktop display of the user interface of the operating system of the server terminal and display data related to the desktop display of the user interface of the operating system of the first client terminal.

3. The method of claim 1, wherein the display data related to running processes is a display data related to a user interface of a program currently running on the first client terminal, and the method further comprises, in response to the server terminal detecting a specific operation performed by an input device connected to the server terminal, switching between the display data related to a currently running program on the first client terminal and a display data related to a currently running program on the server terminal; and
wherein the specific operation performed by an input device connected to the server terminal is an alt-tab key combination, and the method further comprises, switching between display data in an order of display data related to a currently running program on the server terminal and display data related to a currently running program on the first client terminal.

4. A server terminal comprising:
a processor;
a data bus coupled to the processor;
a memory coupled to the processor;
a connection medium to connect and exchange information with other computer terminals; and
a processing logic for:
transmitting an instruction from the server terminal to a first client terminal to enable interconnection between an output display device buffer of the first client terminal and an output display device buffer of the server terminal;
in response to the server terminal connecting the output display device buffer of the server terminal to the input device buffer of the first client terminal, receiving a display data related to running processes of the first client terminal, wherein the display data related to running processes is received by the server terminal, and includes one or more of:
a display data related to a desktop display of a user interface of an operating system running on the first client terminal,
a display data related to a user interface of a program currently running on the first client terminal;
connecting input/output (I/O) functionality of an input device buffer of an operating system of the first client terminal with an input device buffer associated with an operating system of the server terminal; and
in response to connecting the input device buffer of the operating system of the first client terminal to the input device buffer of the operating system of the server terminal, transmitting operations performed by an input device connected to the server terminal to the first client terminal to control the first client terminal.

5. The server terminal of claim 4, wherein the display data related to running processes on the first client terminal is a desktop display of the user interface of the first client terminal, and the processing logic further comprises, in response to the server terminal detecting a specific operation performed by an input device connected to the server terminal, switching from a display data related to a desktop display of a user interface of an operating system of the server terminal to the display data related to a desktop display of a user interface of an operating system of the first client terminal; and
wherein the specific operation performed by an input device connected to the server terminal is an alt-tab key combination, and the processing logic further comprises, switching between display data in an order of display data related to the desktop display of the user interface of the operating system of the server terminal and display data related to the desktop display of the user interface of the operating system of the first client terminal.

6. The server terminal of claim 4, wherein the display data related to running processes is a display data related to a user interface of a program currently running on the first client terminal, and the processing logic further comprises, in response to the server terminal detecting a specific operation performed by an input device connected to the server terminal, switching between the display data related to a currently running program on the first client terminal and a display data related to a currently running program on the server terminal; and
wherein the specific operation performed by an input device connected to the server terminal is an alt-tab key combination, and the processing logic further comprises, switching between display data in an order of display data related to a currently running program on the server terminal and display data related to a currently running program on the first client terminal.

7. A computer-readable medium having stored a plurality of instructions processable by a machine embodied therein, wherein the plurality of instructions, when processed by a machine, causes the machine to:
transmit an instruction from the server terminal to a first client terminal to enable interconnection between an output display device buffer of the first client terminal and an output display device buffer of the server terminal;
in response to the server terminal connecting the output display device buffer of the server terminal to the input device buffer of the first client terminal, receive a display data related to running processes of the first client terminal, wherein the display data related to running processes is received by the server terminal, and includes one or more of:
a display data related to a desktop display of a user interface of an operating system running on the first client terminal,
a display data related to a user interface of a program currently running on the first client terminal;
connect input/output (I/O) functionality of an input device buffer of an operating system of the first client terminal with an input device buffer associated with an operating system of the server terminal; and
in response to connecting the input device buffer of the operating system of the first client terminal to the input device buffer of the operating system of the server terminal, transmit operations performed by an input device connected to the server terminal to the first client terminal to control the first client terminal.

8. The computer-readable medium of claim 7, wherein the display data related to running processes on the first client terminal is a desktop display of the user interface of the first client terminal, and the plurality of instructions further comprises, in response to the server terminal detecting a specific operation performed by an input device connected to the server terminal, switch from a display data related to a desktop display of a user interface of an operating system of the server terminal to the display data related to a desktop display of a user interface of an operating system of the first client terminal; and
wherein the specific operation performed by an input device connected to the server terminal is an alt-tab key combination, and the plurality of instructions further comprises, switch between display data in an order of display data related to the desktop display of the user interface of the operating system of the server terminal and display data related to the desktop display of the user interface of the operating system of the first client terminal.

9. The computer-readable medium of claim 7, wherein the display data related to running processes is a display data related to a user interface of a program currently running on the first client terminal, and the plurality of instructions further comprises, in response to the server terminal detecting a specific operation performed by an input device connected to the server terminal, switch between the display data related to a currently running program on the first client terminal and a display data related to a currently running program on the server terminal; and
wherein the specific operation performed by an input device connected to the server terminal is an alt-tab key combination, and the plurality of instructions further comprises, switch between display data in an order of display data related to a currently running program on the server terminal and display data related to a currently running program on the first client terminal.
